(19) United States
(12) Patent Application Publication
(10) Pub. No.: US 2010/0055447 A1
(43) Pub. Date: Mar. 4, 2010

(54) OPTICAL ARTICLE AND A METHOD FOR PREPARING THE SAME

(75) Inventor: Seo-Yong CHO, Seoul (KR)

Correspondence Address: Seo-Yong Cho, 2-711, Samick Apt., Ichon, Yongsan, Seoul, 151-728, KR

(73) Assignee: Seoul National University Industry Foundation

(21) Appl. No.: 12/200,284

(22) Filed: Aug. 28, 2008

(51) Int. Cl. B32B 5/16; B29D 11/00; B05D 5/06

(52) U.S. Cl. 428/328; 264/1.7; 427/164

(57) ABSTRACT

An optical article includes a light-transmissive substrate and Ti/Sn-containing nanoparticles. The nanoparticles include one or more Ti-rich phases and one or more Sn-rich phases and the phases are arranged in the form of a layered-structure, a network-structure of each other interconnected phases and/or an isolated-structure. Methods of preparing the optical article includes providing Ti/Sn-containing nanoparticles, mixing a curable light-transmissive liquid resin with the Ti/Sn-containing nanoparticles; and curing the liquid resin to form an optical article.

### SUMMARY

In one aspect, an optical article is provided including a light-transmissive substrate; and Ti/Sn-containing nanoparticles where the nanoparticles include one or more Ti-rich phases and one or more Sn-rich phases, and the phases being arranged in the form of a layered-structure, a network-structure of each other interconnected phases and/or an isolated-structure. In some embodiments, the layered-structure is a lamellar structure. In other embodiments, the layered-structure is a core-shell structure.

In some embodiments, the Ti/Sn-containing nanoparticles include one or more compounds of formula (Tiₓ,Sn_{y})O₂, where x is greater than 0.5 and y is less than 0.5 in a Ti-rich phase; and/or where x is less than 0.5 and y is greater than 0.5 in a Sn-rich phase. In some embodiments, x and y are in the following ranges: 0.5<x<0.9 and 0.1<y<0.5 in a Ti-rich phase; and 0.1<x<0.5 and 0.5<y<0.9 in a Sn-rich phase. In each of the embodiments, the sum of x and y is one.

In other embodiments, the Ti-rich phases, the Sn-rich phases, or both the Ti- and Sn-rich phases of the nanoparticles are rutile-type. In yet other embodiments, the size of the nanoparticles is 200 nm or less. In yet other embodiments, a distance between Ti-rich phases, or between Sn-rich phases is 100 nm or less.

In some embodiments, the nanoparticles are dispersed within the substrate. In such embodiments, the content of nanoparticles in the substrate is from about 0.005 wt % to 0.5 wt % based on the total weight of the substrate.

In other embodiments, the nanoparticles are coated onto a surface of the substrate. In yet other embodiments, the optical article also includes a film comprising nanoparticles dispersed therein is coated onto a surface of the substrate.

In some embodiments, the nanoparticles impart an increased refractive index in the optical article as compared to an optical article without the nanoparticles. In some embodiments, the refractive index of the article is at least about 1.5. In some embodiments, the refractive index of the article is less than about 2.7.

In some embodiments, the light-transmissive substrate comprises a polystyrene resin, a polycarbonate resin, a polymethyl methacrylate resin, a polydiethylene glycol bis (allyl carbonate) resin, a vinyl ester resin, a vinyl ether resin, a halogen-containing resin, an olefinic resin, a polyester resin, a polyamide-series resin, a thermoplastic polyurethane resin, a polysulfone resin, a polyphenylene ether resin, a cellulose derivative, a silicone resin, co-polymers thereof, or a mixture of any two or more thereof.

In some embodiments, the optical device is an optical lens, a reflector, or a prism.

In another aspect, a method is provided for preparing an optical article including providing Ti/Sn-containing nanoparticles, where the nanoparticles include one or more Ti-rich phases and one or more Sn-rich phases, where the phases are arranged in the form of a layered-structure, a network-structure of each other interconnected phases and/or an isolated-structure; mixing a curable light-transmissive liquid resin with the nanoparticles; and curing the liquid resin to form the optical article. In some embodiments, the providing Ti/Sn-containing nanoparticles includes inducing spinodal decomposition by heating a Ti/Sn-containing solid solution of nanoparticles to separate the solid solution into one or more Ti-rich phases and one or more Sn-rich phases. In some embodiments, the heating is carried out at a temperature of from about 700° C. to 1400° C.

In some embodiments, the layered-structure is a lamellar structure. In some other embodiments, the nanoparticles have a core-shell structure. In yet other embodiments, the Ti/Sn-containing nanoparticles include one or more compounds of formula (Tiₓ,Sn_{y})O₂, where x is greater than 0.5 and y is less than 0.5 in a Ti-rich phase; and where x is less than 0.5 and y is greater than 0.5 in a Sn-rich phase. In some embodiments, x and y are in the following ranges: 0.5<x<0.9, and 0.1<y<0.5 in a Ti-rich phase; and 0.1<x<0.5 and 0.5<y<0.9 in a Sn-rich phase. In such embodiments, the sum of x and y is one. In additional embodiments, the Ti-rich phases, the Sn-rich phases, or both the Ti- and Sn-rich phases of the nanoparticles are rutile-type.

In some embodiments, the size of the nanoparticles is 200 nm or less. In other embodiments, a distance between the phases consisting of identical component is 100 nm or less.

In some embodiments, the nanoparticles are dispersed in the curable light-transmissive liquid resin. In other embodiments, the content of nanoparticles in the curable composition is from about 0.005 wt % to 0.5 wt % based on the total amount of the liquid resin.

In some embodiments, the refractive index of the optical article is at least about 1.5. In other embodiments, the light-transmissive liquid resin includes a polystyrene resin, a polycarbonate resin, a polymethyl methacrylate resin, a polydiethylene glycol bis (allyl carbonate) resin, a vinyl ester resin, a vinyl ether resin, a halogen-containing resin, an olefinic resin, a polyester resin, a polyamide-series resin, a thermoplastic polyurethane resin, a polysulfone resin, a polyphenylene ether resin, a cellulose derivative, a silicone resin, co-polymers thereof, or a mixture of any two or more thereof.

In another aspect, a method for preparing an optical article includes providing Ti/Sn-containing nanoparticles, where the nanoparticles include one or more Ti-rich phases and one or more Sn-rich phases, where the phases are arranged in the form of a layered-structure, a network-structure of each other interconnected phases and/or an isolated-structure; and coating the nanoparticles onto a surface of a light-transmissive substrate to form an optical article.

In another aspect, a method for preparing an optical article includes providing Ti/Sn-containing nanoparticles, where the nanoparticles include one or more Ti-rich phases and one or more Sn-rich phases, and the phases are arranged in the form of a layered-structure, a network-structure of each other interconnected phases and/or an isolated-structure; mixing a curable light-transmissive liquid resin with the nanoparticles to form a composition; coating the composition onto a surface of a light-transmissive substrate; and curing the curable light-transmissive liquid resin form a film on the substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1. is a scheme showing an illustrative embodiment of the layered-structure among the structures Ti/Sn-containing nanoparticles, according to one embodiment.

FIG. 2. is a scheme showing an illustrative embodiment of the network-structure of each other interconnected phases among the structures Ti/Sn-containing nanoparticles, according to one embodiment.

FIG. 3. is a scheme of an illustrative embodiment of the isolated structure among the structures Ti/Sn-containing nanoparticles, according to one embodiment.

FIG. 4 is a scheme of an illustrative embodiment of the structure of a combination of layered-structure, network-structure of each other interconnected phases and/or isolated structure among the structures Ti/Sn-containing nanoparticles, according to one embodiment.

FIG. 5 is a phase diagram of an illustrative embodiment of the TiO₂—SnO₂ system.

FIG. 6 is a scheme of an illustrative embodiment of the optical article where Ti/Sn-containing nanoparticles are dispersed within light-transmissive substrate, according to one embodiment.

FIG. 7 is a scheme of an illustrative embodiment of the optical article where Ti/Sn-containing nanoparticles are coated on the surface of the light-transmissive substrate, according to one embodiment.

FIG. 8 is a scheme of an illustrative embodiment of the optical article where a film dispersed with Ti/Sn-containing nanoparticles is coated on the light-transmissive substrate, according to one embodiment.

FIG. 9 is an SEM image of an illustrative embodiment of Ti/Sn-containing nanoparticles prepared according to one embodiment

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

### Ti/Sn-Containing Nanoparticles

Ti/Sn-containing nanoparticles have Ti-rich phases and Sn-rich phases, and may be in the form of a solid-solution represented by formula (Tiₓ,Sₙy)O₂. In the formula, x in the Ti-rich phase is greater than 0.5, according to some embodiments. For example, x may be greater than 0.5, but less than 0.9, or greater than 0.6, but less than 0.8. In the Sn-rich phase, y is less than 0.5, according to some embodiments. For example, y may be greater than 0.1, but less than 0.5, or y may be greater than 0.2, but less than 0.4.

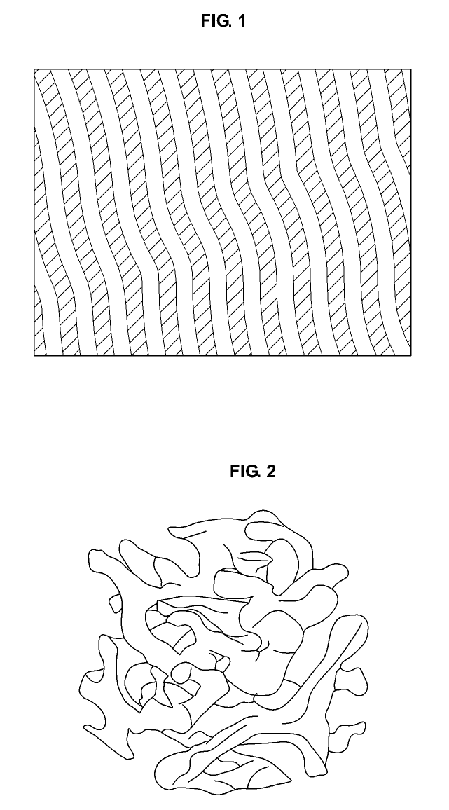

The phases may be arranged in the form of a layered-structure, network-structure of each other interconnected phases and/or isolated structure. As used herein, a “layered-structure” is a lamellar structure in a form where one or more Ti-rich phases and one or more Sn-rich phases are layered one after the other. The layered-structure may have a structure where the Ti-rich phase and Sn-rich phase are layered one after the other in the form of a concentric circle outwardly from the center of the particle. Alternatively, it may have a structure where layers of the Ti-rich phase and Sn-rich phase that are layered in a parallel fashion, one after the other, and are discontinuously distributed randomly within the nanoparticles. FIG. 1 illustrates one such illustrative scheme, according to one embodiment.

In another aspect, the structure forming a concentric circle may be in a shell form. Hence, in some embodiments, the structure forming a concentric circle is a form having a Ti-rich phase and a Sn-rich phase, i.e., a core-shell form. In such form, the core-shell may have a form where the Ti-rich phase is the core and the Sn-rich phase is the shell, or vice versa.

As used herein, a “network-structure of each other interconnected phase” refers to a structure where one phase is continuously dispersed in another phase, between Ti- or Sn-rich phases, and the phases are connected to each other in two dimensions or three dimensions. FIG. 2 illustrates an illustrative scheme of such structure, according to one such embodiment.

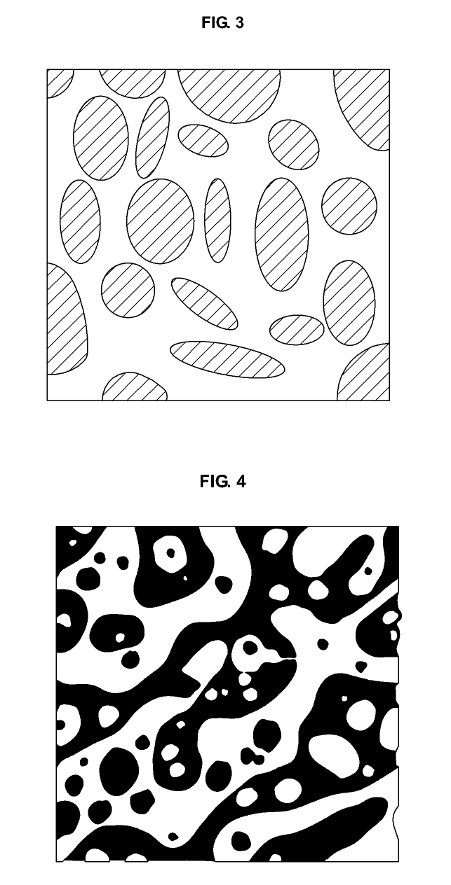

As used herein, a “isolated structure” refers to a structure where one of the Ti- or Sn-rich phases is not continuous and dispersed separately among the other continuous phases. The phase having a larger Ti or Sn content within the nanoparticles forms the continuous phase, and the phase of lesser content forms the isolated phase. The isolated phase may have a specific shape such as a sphere, oval, or needle, or may be an irregular shape (amorphous). Also, particles having different shapes may be present. FIG. 3 illustrates an illustrative scheme of such structure, according to one embodiment.

In another aspect, one of a layered-structure, a network-structure of each other interconnected phases or an isolated structure may be formed in the entire region of the nanoparticles. In yet another aspect such structures may be formed partially. For example, some region of the nanoparticles may have a layered-structure, and the other region of the nanoparticles may have an isolated structure. Other combination of different structures may be formed in the nanoparticles.

In another aspect, the structure of the nanoparticles may be in the form of any combination of layered structure, network-structure of each other interconnected phases, or isolated structures. For example, nanoparticles may have a structure wherein the part in a layered-structure and the part in a network-structure of each other interconnected phases are spatially separated within one nanoparticle, so that the nanoparticles may be microscopically divided into a layered-structure or network-structure of each other interconnected phases. Of course, other combination of phases may be made.

In another aspect, the layered-structure, network-structure of each other interconnected phases or isolated structure may be microscopically mixed with each other. FIG. 4 illustrates an illustrative scheme of such structure, according to one embodiment.

In some aspects, various shapes of Ti/Sn-containing nanoparticles may be employed. Ti/Sn-containing nanoparticle may have a variety of shapes so far as it does not affect the light-transmission by being used for optical purposes. The particles may have a specific shape such as a sphere, oval, or needle, or may be an irregular shape (amorphous). The shape may vary depending on the preparation method of the particle. The spherical or oval shape particle may suit the optical purpose.

In some embodiments, the average size of Ti/Sn-containing nanoparticles is from about 0.5 nm to about 200 nm, from about 1 nm to about 100 nm, from about 1 nm to 50 nm, or from about 1 nm to about 20 nm, or from about 1 nm to about 10 nm In other aspect, the average size of Ti/Sn-containing nanoparticles is about 1 nm or more, or about 5 nm or more. If the nanoparticle has a shape other than a circle, the size of each particle may be defined by the diameter of the circumcircle. If nanoparticles larger than the above range are used, they present achromatic colors (for example, are whitened), and thus may not be suitable to be used as an optical article.

In another aspect, the distance between the phases identical components is about 100 nm or less, about 50 nm or less, about 25 nm or less, about 10 nm or less, and or about 5 nm or less. In some embodiments, the distance between the phases of identical components is from about 0.5 to 100 nm, from about 1 nm to 500 nm, from about 1 nm to 25 nm, or from about 1 nm to 10 nm. As used herein, the distance between the phases consisting of identical components refers to the minimum distance between Ti-rich phases with a Sn-rich phase between them, or the minimum distance between the Sn-rich phases with a Ti-rich phase between them in a layered-structure, network-structure of each other interconnected phases and/or isolated structure.

Ti-rich phases or Sn-rich phases may be anatase-type or rutile-type. In an illustrative aspect, Ti/Sn-containing nanoparticles may have rutile-type because titanium oxide of anatase-type is activated when receiving light energy, thus presenting an effect of decomposing organic materials.

### Providing Ti/Sn-Containing Nanoparticles

TiO₂/SnO₂-containing solid solution nanoparticles may be prepared from TiO₂ and SnO₂ precursors. Thus, in some embodiments, TiO₂ precursors include, but are not limited to, titanium alkoxides, titanium halides, titanium salt, and mixtures thereof. Titanium alkoxide may be exemplified by titanium tetra-methoxide, titanium tetra-ethoxide, titanium tetra-isopropoxide, titanium tetra-butoxide, titanium monomethoxy-triisopropoxide, titanium dimethoxy-diisopropoxide, etc. Titanium halide may be exemplified by titanium tetra-chloride. Titanium salts may be exemplified by Ti(ClO)₂, Ti(ClO)₃, Ti(ClO)₄, Ti(ClO₂)₂, Ti(ClO₂)₃, Ti(ClO₂)₄, Ti(ClO₃)₂, Ti(ClO₃)₃, Ti(ClO₃)₄, Ti(ClO₄)₂, Ti(ClO₄)₃, Ti(ClO₄)₄, Ti(CO₃)₂, Ti(HCO₃)₂, Ti(HCO₃)₃, Ti(HCO₃)₄, Ti(NO₂)₂, Ti(NO₂)₃, Ti(NO₂)₄Ti(NO₃)₂, Ti(NO₃)₃, Ti(NO₃)₄, Ti(SO₃)₂, Ti(SO₄)₂, Ti₂(HPO₄)₃, Ti₂(SO₃)₃, Ti₂(SO₄)₃TiSO₃, and TiSO₄.

SnO₂ precursors include, but are not limited to, tin alkoxide, tin halide, tin salt, etc., but are not limited thereto. Tin alkoxides include, but are not limited to, tin tetra-methoxide, tin tetra-ethoxide, tin tetra-isopropoxide, tin tetra-butoxide, tin monomethoxy-triisopropoxide, tin dimethoxy-diisopropoxide, etc. Tin halides include, but are not limited to, tin tetra-chloride, etc. Tin salts include, but are not limited to, Sn(ClO)₂, Sn(ClO)₃, Sn(ClO)₄, Sn(ClO₂)₂, Sn(ClO₂)₃, Sn(ClO₂)₄, Sn(ClO₃)₂, Sn(ClO₃)₃, Sn(ClO₃)₄, Sn(ClO₄)₂, Sn(ClO₄)₃, Sn(ClO₄)₄, Sn(CO₃)₂, Sn(HCO₃)₂, Sn(HCO₃)₃, Sn(HCO₃)₄, Sn(NO₂)₂, Sn(NO₂)₃, Sn(NO₂)₄, Sn(NO₃)₂, Sn(NO₃)₃, Sn(NO₃)₄, Sn(SO₃)₂, Sn(SO₄)₂, Sn₂(SO₃)₃, Sn₂(SO₄)₃, SnCO₃, SnSO₃, and SnSO₄.

Nanometer sized composite particles of TiO₂ and SnO₂ are microscopically mixed uniformly (i.e., solid solution form) may be prepared by a preparation method well known in the pertinent art wherein nanoparticles are generally prepared from the precursors. For example, they may be obtained by precipitation, sol-gel synthesis, ethylene glycol process, hydrothermal process, thermochemical synthesis (or spray conversion), flame hydrolysis, seeded growth, chemical vapor deposition, etc.

In one aspect, TiO₂/SnO₂ solid solution nanoparticles are prepared via a sol-gel method. In some embodiments, the nanoparticles are prepared by adding an acidic solution of TiCl₄ and SnCl₄ to a basic solution (NH₄OH). Exemplary sol-gel chemical reactions are as shown below:

TiCl₄+4 NH₄OH→TiO₂+4 NH₄Cl+2 H₂O

SnCl₄+4 NH₄OH→SnO₂+4 NH₄Cl+2 H₂O

Such sol-gel processes allow for mass production at low cost, and in high purity.

In another aspect, in accordance with the sol-gel synthesis, titanium alkoxide and tin alkoxide may be used as precursors. TiO₂/SnO₂ solid solution particles of nanometers may be obtained by dissolving a catalyst (e.g., ammonia (NH₃)) in a mixture of water and alcohol (e.g., methanol, ethanol, propanol, butanol, pentanol, etc. and a mixture thereof), and dissolving a titanium alkoxide and a tin alkoxide in the mixture solution. Nanoparticles of the TiO₂/SnO₂ solid solution are then formed by hydrolysis and polycondensation. Exemplary chemical reactions are as shown below:

Ti(OR)₄+4 H₂O→TiO₂+4ROH+2 H₂O

Sn(OR)₄+4 H₂O→SnO₂+4ROH+2 H₂O.

In such reactions, R is an alkyl group, alkenyl group or aromatic group having 1 to 6 carbon atoms, substituted or unsubstituted with one or more halogens.

Factors that can affect the size and shape of the particle in the sol-gel synthesis include the pH of solution, type and content of catalyst, type and number of substitutions of precursor (steric, inductive effect, etc.), content of water, type of solvent, concentration of starting material, temperature, type and concentration of surfactant that may be further used, treatment and type of acid or base that may be further used. In particular, the pH of the solution is an important factor, and in order to prepare a particle type sol such as powder, a basic solution is used. A person having ordinary skill in the art may properly select the pH and type of catalyst to obtain a particle of the desired size and shape.

In another aspect, TiO₂/SnO₂ solid solutions may be prepared via an ethylene glycol process. In some embodiments of the process, ethylene glycol is used as a solvent and is reacted with a TiO₂ precursor and a SnO₂ precursor at an elevated temperature to form a Ti/Sn-ethylene glycolide. In some embodiments, the elevated temperature is at least about 170° C. In other embodiments, the elevated temperature is from about 170° C. to 300° C. TiO₂ precursors for use in the ethylene glycol process include, but are not limited to TiCl₄ and titanium alkoxide. SnO₂ precursors for use in the ethylene glycol process include, but are not limited to SnCl₄ and tin alkoxides. Subsequent to formation, the Ti/Sn-ethylene glycolide is heated to at least 400° C. to obtain a TiO₂/SnO₂ solid solution.

In another aspect, hydrothermal processes may be used to form crystalline TiO₂/SnO₂ solid solutions. In some embodiments, TiO₂/SnO₂ solid solutions may be obtained through a dissolution-reprecipitation process by reacting a titanium salt, a tin salt, an amorphous titanium oxide or an amorphous tin oxide, at high temperature and under high pressure, in the presence of a mineralizing agent. An exemplary chemical reaction is: a-TiO₂→c-TiO₂; where “a” indicates amorphous and “c” indicates crystalline. The hydrothermal process has an advantage that crystalline oxide particles may be synthesized in a uniform size and shape. Particles having various phase fractions, sizes and shapes may be obtained by adjusting the pressure, temperature, and type and amount of mineralizing agent, etc. or adding a surfactant, etc. during the reaction.

In another aspect, TiO₂/SnO₂ solid solution nanoparticles prepared through a method exemplified in the above or sold in the market are heated to obtain Ti/Sn-containing nanoparticles having one or more Ti-rich phases and one or more Sn-rich phases, where the phases are arranged in the form of a layered-structure, a network-structure of each other interconnected phases and/or an isolated-structure.

It is known that TiO₂/SnO₂ solid solution systems perform phase isolation by spinodal decomposition under a composition and temperature condition within the coherent spinodal. Yuan T C, Virkar A V, “Kinetics Of The Spinodal Decomposition In The TiO₂-SnO₂ System: The Effect Of Aliovalent Dopants” Journal of the American Ceramic Society. 1988; 71:12-21. 57; Nambu S, Sato A, Sagala D A. “Computer Simulation Of Kinetics Of Spinodal Decomposition In The Tetragonal TiO₂—SnO₂ System” Journal of the American Ceramic Society. 1992; 75:1906-13.

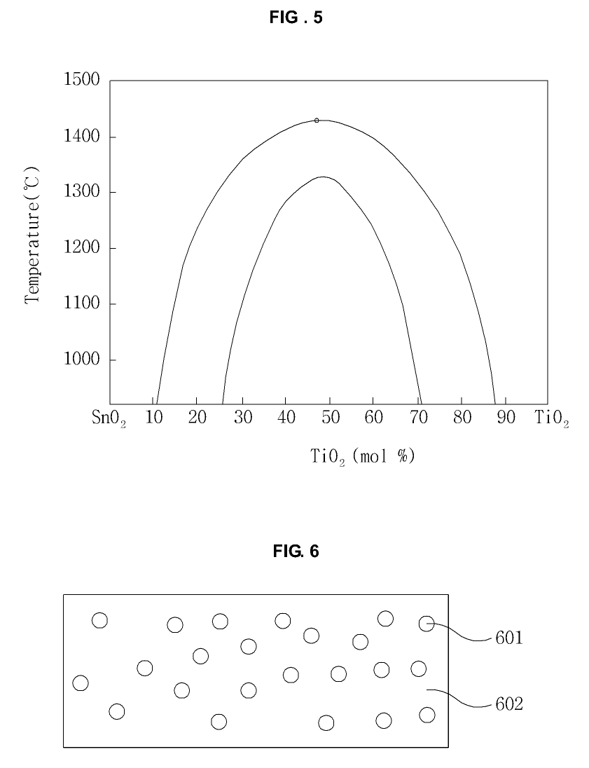

FIG. 5 is an illustration of the phase diagram of a TiO₂/SnO₂ solid solution system. As illustrated in FIG. 5, the TiO₂/SnO₂ System has a miscibility gap that is almost symmetric within the phase boundary curve (501) that has a critical composition approximately 47±2 mol % at approximately 1430±5° C. Ti/Sn-containing nanoparticles comprising one or more Ti-rich phases and one or more Sn-rich phases, where the phases are arranged in the form of a layered-structure, a network-structure of each other interconnected phases, and/or an isolated-structure may be obtained by heat treating a composition within the phase boundary curve and range of temperature, and under a composition within the coherent spinodal curve (502) and temperature range.

Irrespective of the theory, in the case of a condition within the coherent spinodal curve (502), phase isolation is generated by spinodal decomposition. In the case of a condition between the phase boundary curve (501) and coherent spinodal curve (502), phase isolation may be generated by nucleation and growth mechanisms. According to one embodiment, to obtain a nanoparticle having the desired phase structure, heat treatment within the coherent spinodal curve (502) is conducted.

Such heat treatment is performed by any method well known in the pertinent art at a temperature of from about 700° C. to about 1400° C. Additionally, such heat treatment may be performed for a sufficient period of time in order to achieve nanoparticles of the desired structure at a certain temperature. Also, whenever necessary, the temperature may be raised or lowered within the range of temperature, thus performing the heat treatment in any cooling rate or heating rate. Depending on the condition of heat treatment, the composition of the Ti-rich phase and the Sn-rich phase and their arrangement in the nanoparticles may vary.

The molar ratio of the Ti:Sn in the TiO₂/SnO₂ solid solution nanoparticles is from about 0.2 to 0.8, according to some embodiment, from about 0.3 to 0.7, according to other embodiments, from about 0.4 to 0.6, in yet other embodiments. Thus, TiO₂/SnO₂ solid solution nanoparticles having a molar ratio of the above ranges may be obtained by adjusting the amount of TiO₂ precursor or SnO₂ precursor used at the time of preparing TiO₂/SnO₂ solid solution nanoparticles.

In another aspect, a layered-structure, a network-structure of each other interconnected phases and/or an isolated-structure may be obtained from TiO₂ precursor and SnO₂ precursor by performing an oxidation reaction and heat treatment at the same time. For example, droplets can be generated by spraying a solution of TiO₂ precursor and SnO₂ precursor. The solution of the precursors is prepared in water or organic solutions such as alcohol. The droplets are passed through an atmosphere comprising oxygen at elevated temperatures from about 700° C. to 1400° C. Phase isolation is generated between the Ti- and Sn-rich phases at the time TiO₂/SnO₂ oxide is formed by the oxidation reaction and heat treatment. Ti/Sn-containing nanoparticles may be obtained by spraying the droplet into a flame of high temperature formed by mixing hydrogen-oxygen-air.

In one aspect, in addition to a TiO₂ and/or a SnO₂ precursor, other metal oxide precursors may be used to obtain nanoparticles comprising metal oxide other than TiO₂ and/or a SnO₂. Example of the metal oxide precursors include, but are not limited to, aluminum oxide, zinc oxide, vanadium oxide, niobium oxide, tantalum oxide, molybdenum oxide, tungsten oxide, manganese oxide, cobalt oxide, nickel oxide, copper oxide, indium oxide, lead oxide, antimony oxide, and bismuth oxide. The precursors may enhance or inhibit phase isolation due to the heat treatment as described above. For example, trivalent aluminum may increase the decomposition rate, but pentavalent tantalum may inhibit the decomposition rate.

### A Light-Transmissive Substrate

Light-transmissive substrates may be any light-transmissive plastic that may be used as an optical material. For example, light-transmissive plastics include, but are not limited to, styrenic resins (polystyrene; PS); (meth)acrylic resins (polymethyl methacrylate; PMMA); polydiethylene glycol bis (allyl carbonate) resins; vinyl ester-series resins; vinyl ether-series resins; halogen-containing resins; olefinic resins (inclusive of alicyclic olefinic resins); polycarbonate(PC)-series resins; polyester-series resins; polyamide-series resins; thermoplastic polyurethane-series resins; polysulfone-series resins (e.g., polyether sulfone, polysulfone); polyphenylene ether-series resins (e.g., a polymer of 2,6-xylenol); cellulose derivatives (e.g., cellulose esters, cellulose carbamates, cellulose ethers); silicone resins (e.g., polydimethyl siloxane, polymethyl phenyl siloxane); or blends or co-polymers thereof.

As used herein, styrenic resins include homo- or copolymers of styrenic monomers. Styrenic resins include, but are not limited to polystyrene, styrene-□-methylstyrene copolymer, styrene-vinyl toluene copolymer, and copolymers of styrenic monomers with copolymerizable monomers such as (meth)acrylic monomers, maleic anhydride, maleimide-series monomers, or a diene. Styrenic copolymer includes, for example, styrene-butadiene copolymer, styrene-acrylonitrile copolymer (AS resin), a copolymer of styrene and a (meth)acrylic monomer [e.g., styrene-methyl methacrylate copolymer, styrene-methyl methacrylate-(meth)acrylate copolymer, styrene-methyl methacrylate-(meth)acrylic acid copolymer], styrene-maleic anhydride copolymer.

As used herein, (meth)acrylic resins, include homo- or copolymer of a (meth)acrylic monomer and a copolymer of a (meth)acrylic monomer and a co-polymerizable monomer. (Meth)acrylic monomers, include, (meth)acrylic acid; C₁₋₁₀ alkyl (meth)acrylates such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate and 2-ethylhexyl (meth)acrylate; aryl (meth)acrylates such as phenyl (meth)acrylate; hydroxyalkyl (meth)acrylate such as hydroxyethyl (meth)acrylate and hydroxypropyl (meth)acrylate; glycidyl (meth)acrylate; N,N-dialkylaminoalkyl (meth)acrylate; (meth)acrylonitrile; (meth)acrylate having an alicyclic hydrocarbon ring such as tricyclodemaye. The copolymerizable monomers include the above styrenic monomer, a vinyl ester-series monomer, maleic anhydride, maleic acid, and fumaric acid. These monomers may be used singly or in combination.

(Meth)acrylic resins include, but are not limited to, poly(meth)acrylates such as polymethyl methacrylate, methyl methacrylate-(meth)acrylic acid copolymers, methyl methacrylate-(meth)acrylate copolymers, methyl methacrylate-acrylate-(meth)acrylic acid copolymers, and (meth)acrylate-styrene copolymers (MS resin).

Vinyl ester-series resins include, but are not limited to, homo- or copolymers of vinyl ester-series monomers (e.g. polyvinyl acetate, polyvinyl propionate), copolymers of vinyl ester-series monomers with copolymerizable monomers (e.g. ethylene-vinyl acetate copolymer, vinyl acetate-vinyl chloride copolymer, vinyl acetate-(meth)acrylate copolymer) and derivatives thereof. The derivative of the vinyl ester-series resin includes polyvinyl alcohol, ethylene-vinyl alcohol copolymer, polyvinyl acetal resin and the like.

Vinyl ether resins include, but are not limited to homo- or copolymers of vinyl C₁₋₁₀ alkyl ethers such as vinyl methyl ether, vinyl ethyl ether, vinyl propyl ether, and vinyl t-butyl ether, a copolymer of vinyl C₁₋₁₀ alkyl ether and a copolymerizable monomer (e.g. vinyl alkyl ether-maleic anhydride copolymer).

Halogen-containing resins include, but are not limited to, polyvinyl chloride, poly(vinylidene fluoride), vinyl chloride-vinyl acetate copolymer, vinyl chloride-(meth)acrylate copolymer, and vinylidene chloride-(meth)acrylate copolymer.

Olefinic resins include, but are not limited to, homopolymers of olefins such as polyethylene and polypropylene, copolymers such as ethylene-vinyl acetate copolymer, ethylene-vinyl alcohol copolymer, ethylene-(meth)acrylic acid copolymer and ethylene-(meth)acrylate copolymer. Alicyclic olefinic resins include, but are not limited to homo- or copolymers of cyclic olefins such as norbornene and dicyclopentadiene (e.g., a polymer having an alicyclic hydrocarbon group such as tricyclodemaye which is sterically rigid), copolymers of the cyclic olefin with a copolymerizable monomer (e.g., ethylene-norbornene copolymer, propylene-norbornene copolymer). Some alicyclic olefinic resins are commercially available under the tradename Arton® (available from JSR Corporation) and Zeonex® (available from Nippon Zeon Co., LTD).

Polycarbonate resins include, but are not limited to, aromatic polycarbonates based on bisphenols (e.g. bisphenolA) and aliphatic polycarbonates such as diethylene glycol bisallyl carbonates. Specific examples include polycarbonate obtained by polymerization of the allyl carbonates of polyols of which mention may be made of ethyleneglycol bis allyl carbonate, diethyleneglycol bis 2-methyl carbonate, diethyleneglycol bis(allyl carbonate), ethyleneglycol bis(2-chloro allyl carbonate), triethyleneglycol bis(allyl carbonate), 1,3-propanediol bis(allyl carbonate), propylene glycol bis(2-ethyl allyl carbonate), 1,3-butylenediol bis(allyl carbonate), 1,4-butenediol bis(2-bromo allyl carbonate), dipropyleneglycol bis(allyl carbonate), trimethyleneglycol bis(2-ethyl allyl carbonate), pentamethyleneglycol bis(allyl carbonate), isopropylene bis phenol-A bis (allyl carbonate). Polycarbonates are commercially available under a variety of tradenames. On commercial example is a polymer obtained by polymerization of (bis)allyl carbonate with diethyleneglycol, and is sold under the trade name CR 39® from PPG Industries.

Polyester resins include, but are not limited to, aromatic polyesters obtainable from an aromatic dicarboxylic acid, such as terephthalic acid; polyC₂₋₄ alkylene terephthalates such as polyethylene terephthalate and polybutylene terephthalate; polyC₂₋₄ alkylene naphthalates; and copolyesters of C₂₋₄ alkylene arylates such as C₂₋₄ alkylene terephthalates and/or C₂₋₄ alkylene naphthalates. In some embodiments, the polyester resin is present at not less then 50 wt %. Copolyesters include copolyesters of polyC₂₋₄ alkylene acrylates; C₂₋₄ alkylene glycols substituted with a polyoxyC₂₋₄ alkylene glycol; C₆₋₁₀ alkylene glycols; alicyclic diols such as cyclohexane dimethanol and hydrogenated bisphenolA; diols having aromatic ring such as 9,9-bis(4-(2-hydroxyethoxy)phenyl)fluorene having a fluorenone side chain, a bisphenolA, bisphenolA-alkylene oxide adduct, or the like; aromatic dicarboxylic acids substituted with an unsymmetric aromatic dicarboxylic acid such as phthalic acid or isophthalic acid; aliphatic C₆₋₁₂ dicarboxylic acids such as adipic acid or the like; or mixtures or copolymers of any two or more such materials. Polyester resins also include, but are not limited to polyarylate resins, aliphatic polyesters obtainable from an aliphatic dicarboxylic acid such as adipic acid, a homo- or copolymer of a lactone such as □-caprolactone, or mixtures of any two or more such materials.

Polyamide resins include, but are not limited to aliphatic polyamides such as nylon 46, nylon 6, nylon 66, nylon 610, nylon 612, nylon 11, and nylon 12, polyamides obtained from dicarboxylic acids (e.g., terephthalic acid, isophthalic acid, adipic acid) and diamines (e.g., hexamethylene diamine, m-xylylenediamine). Polyamide resins may be homo- or copolymer of lactams such as □-caprolactam, and is not limited to a homopolyamide but may be a copolyamide.

Cellulose derivatives include, but are not limited to, aliphatic organic acid esters (e.g., C₁₋₆ organic acid esters such as cellulose acetates (e.g., cellulose diacetate, cellulose triacetate), cellulose propionate, cellulose butyrate, cellulose acetate propionate, and cellulose acetate butyrate), aromatic organic acid esters (e.g. C₇₋₁₂ aromatic carboxylic acid esters such as cellulose phthalate and cellulose benzoate), inorganic acid esters (e.g., cellulose phosphate, cellulose sulfate), cellulose carbamates (e.g. cellulose phenylcarbamate), cellulose ethers (e.g., cyanoethylcellulose, hydroxyC₂₋₄ alkyl celluloses such as hydroxyethylcellulose and hydroxypropylcellulose: C₁₋₆ alkyl celluloses such as methyl cellulose and ethyl cellulose; carboxymethyl celluloses; benzyl cellulose, acetyl alkyl cellulose, a salt of any of the preceding, or a mixture of any two or more such materials.

In some embodiments, and as eluded to above, multiple polymers may be used in combination to form the substrates or the curable liquid resins. For example, and without limitation, in the case of the use of a cellulose derivative, a cellulose ester (e.g., a cellulose C₂₋₄ alkyl carboxylic acid ester such as cellulose diacetate, cellulose triacetate, cellulose acetate propionate and cellulose acetate butyrate) is employed as at least one resin, and the cellulose derivative may be combined with the other resins.

In some embodiments, the resin(s) include additional additives such as UV-absorbers, antioxidants, dyes, antistatic agents, releasing agents, or other additives known to those of skill in the art.

In one aspect, the nanoparticles are dispersed throughout the light-transmissive substrate. FIG. 6 illustrates such an embodiment. In FIG. 6, nanoparticles 601 are distributed throughout the light-transmissive substrate 602.

In one embodiment, a liquid resin dispersed with nanoparticles is prepared by mixing a light-transmissive liquid resin with the Ti/Sn-containing nanoparticles. For example, a liquid resin dispersed with nanoparticles may be obtained by heating the thermoplastic resin to a temperature of at least the glass transition temperature (T_{g}) of the resin, and then mixing it with the nanoparticles to be dispersed. An optical article (e.g., optical lens, etc.) of the desired shape may then be prepared by curing or processing (e.g., injection molding, extrusion molding, plate molding) the liquid resin. Alternatively, an optical article of the desired shape may be prepared by suitably processing (e.g., casting) by first mixing the liquid phase monomer or oligomer of the thermosetting resin or thermoplastic resin with nanoparticles, and then adding any polymerization initiator, well known in the pertinent art.

In one aspect, dispersants known to those of skill in the art may also be used to aid in dispersion of the nanoparticles throughout the resin. In other aspect, nanoparticles may be coated with a polymer shell by known methods. A type of the polymer may be similar with a type of a substrate resin material so that the nanoparticles a having polymer shell may be well dispersed in a liquid resin. For example, nanoparticles may be coated with polymethyl methacrylate(PMMA). The nanoparticles having a PMMA shell may be dispersed well in a liquid resin for forming a substrate.

In some embodiments, the nanoparticles are present in the light-transmissive substrate from about 0.005 wt % to 0.5 wt % based on the total amount of the substrate. In other embodiments the nanoparticles are present in the light-transmissive substrate from about 0.008 wt % to 0.1 wt %, or from about 0.01 wt % to 0.03 wt %.

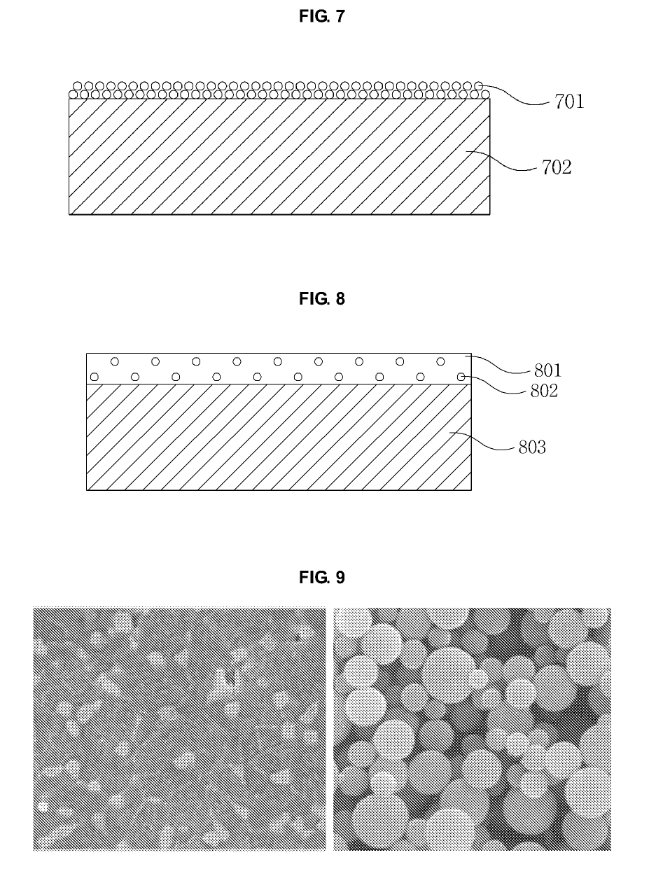

In another aspect, the nanoparticles are coated on the surface of the light-transmissive substrate. FIG. 7 illustrates such an embodiment. Referring to FIG. 7, a nanoparticle 701 is deposited on the surface of a light-transmissive substrate 702. The Ti/Sn-containing nanoparticles may be coated on the surface of the light-transmissive substrate by any method well known in the pertinent art, such as by physical vapor deposition (PVD: sputtering, ion plating, etc.), chemical vapor deposition (CVD: heat, plasma, optic, etc.), dip coating, spray coating, bar coating, spin coating, brushing, roll coating, die coating, knife coating, squeezing, doctor blade process, screen printing, or combinations of any two or more such processes.

In another aspect, a dispersion solution of nanoparticles is prepared by dissolving the nanoparticles in a solvent such as water; a lower alcohol of C₁-C₆ such as methanol, ethanol, propanol, isopropyl alcohol, butyl alcohol, isobutyl alcohol, or diacetone alcohol, a higher alcohol such as polyvinyl alcohol; an acetate such as methylacetate, ethylacetate, isopropylacetate, n-butylacetate; a cellosolveacetate; an alkyl cellosolve such as methylcellosolve, ethylcellosolve, butylcellosolve, isopropylcellosolve; n,n-dimethylformamide (DMF); n-methylpyrrolidinone (NMP); tetrahydrofuran (THF); alkylene glycols such as propyleneglycolmonomethylether and hexyleneglycol; acetylacetone; non-polar solvents such as benzene, toluene, or alkanes; or mixtures of any two or more thereof. Such dispersion solutions may be coated on the surface of a solid substrate, and nanoparticles may be coated on the surface of the light-transmissive substrate by evaporating/drying the solvent.

In another aspect, a film is coated on the surface of the light-transmissive substrate, and nanoparticles are be dispersed in the film. FIG. 8 illustrates such an embodiment. Referring to FIG. 8, a film 801, having nanoparticles 802 dispersed throughout, is coated on a light-transmissive substrate 803.

In some embodiments, the film coated on the surface of the light-transmissive substrate may be a film formed of a plastic material that is similar to the substrate described above, or hard coating film, antireflection film, water-repellent film, hard coating film, antifogging film, anti-wear film, etc. which are well known in the pertinent art. In other embodiment, liquid resin having nanoparticles dispersed throughout is obtained by mixing the resin with the Ti/Sn-containing nanoparticles. Such dispersions may be coated on the surface of the substrate by any known coating method. The coated film is fixed on the surface of the substrate by processes well known in the pertinent art such as curing, polymerization, etc.

Where Ti/Sn nanoparticles are coated on the surface of the light-transmissive substrate, or fixed in a form dispersed on the film, the light-transmissive substrate may be a polymeric or plastic material as described above, or an inorganic glass (SiO₂ type material).

Ti/Sn-containing nanoparticles having one or more Ti-rich phases and one or more Sn-rich phases, where the phases are arranged in the form of a layered-structure, a network-structure of each other interconnected phases and/or an isolated-structure have a refractive index higher than the light-transmissive substrate. Thus, in some embodiments, the nanoparticles are used to provide a high refractive index optical article. Because the liquid resins with dispersed nanoparticles are amenable to injection molding, or other curative and shape-producing processes, unique shapes may be produced. For example, aspherical lens may be prepared, thus providing a reduced distortion view through the lens.

The refractive index (RI) of inorganic glass or organic glass, which is the light-transmissive substrate generally used, is approximately 1.5. For example, inorganic glass has an RI of 1.52, CR-39® has an RI of 1.498, and polycarbonate has an RI of 1.568. Lenses having an RI of at least 1.6 are also commercially available. Dispersions of Ti/Sn-containing nanoparticles throughout light-transmissive substrates, increases the refractive index of the optical article. Thus, it may be possible to prepare optical articles, such as lenses, that have a thinner profile, but the same optical effect, as a thicker lens. As such, according to some embodiments, the refractive index of an optical article may be at least about 1.5, at least about 1.6, at least about 1.65, at least about 1.7, or at least about 1.8 In other embodiments, the refractive index of an optical article may be less than 2.7, or 2.5 or less. The refractive index of an article may be lower than that of titanium dioxide which is about 2.7. The refractive index of the optical article may be determined depending on the amount of Ti/Sn-containing nanoparticles being used, and a person having ordinary skill in the art may properly select the amount of Ti/Sn-containing nanoparticles required to obtain the desired refractive index.

Ti/Sn-containing nanoparticles dispersed in light-transmissive substrates are resistant to hazing, or eliminate hazing, due to the Sn-rich phases that may act as a buffer. This is in contrast to materials using only TiO₂, which may lead to hazing of the substrates. The optical articles disclosed herein may be used in any field of optical material which requires high refractive index. For example, the optical articles may be used as an article comprising various optical devices such as optical communication devices, optical storage devices, optical measurement/control devices, medical optical instruments, and they may be processed into optical lens such as aspherical lenses, GRIN (Gradient-index) lenses, ball lenses, reflectors, or prisms.

Titanium oxide has a property of absorbing visible and ultraviolet light, and thus Ti/Sn-containing nanoparticles have the property of blocking visible and ultraviolet light from the optical articles.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

In general, “substituted” refers to a group, as defined below (e.g., an alkyl or aryl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls(oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched alkyl groups having from 1 to 20 carbon atoms or, in some embodiments, from 1 to 12, 1 to 8, 1 to 6, or 1 to 4 carbon atoms. Alkyl groups further include cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above. Where the term haloalkyl is used, the alkyl group is substituted with one or more halogen atoms.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

As used herein, halogen can refer to F, Cl, Br, or I.

As used herein, ammonium, or quaternary amine, refers to groups or ions having the following structure, ⁺NR^{a}R^{b}R^{c}R^{d}, where R^{a}, R^{b}, R^{c}, and R^{d} are independently selected from H and alkyl groups. Thus, all of the R^{a-d} groups may be the same or different. Alkyl ammonium refers to ammonium groups having one, two, three, or four alkyl groups, while tetralkylammonium refers to ammonium groups having four alkyl groups. Mixed alkyl ammoniums are those ammonium having two, three, or four alkyl groups where at least one of the alkyl groups is different from the other alkyl groups.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present embodiments, thus generally described, will be understood more readily by reference to the following examples, which are provided by way of illustration and are not intended to be limiting of the present technology in any way.

### EXAMPLES

The present technology is further illustrated by the following examples, which should not be construed as limiting in any way.

### Example 1

TiCl₄ and SnCl₄ are used as starting materials. Distilled water is used as a solvent and the ratio Ti/Sn is fixed at 1. The droplet generated from the ultrasonic transducer is carried by nitrogen to the quartz tube (inner diameter=30 mm) and the flow rate of the carrier gas is at 1 liter/min. After obtaining nanoparticles containing titanium oxide and tin oxide by pyrolyzing the droplet under an atmosphere comprising oxygen, it is heat treated continuously at about 1400° C. to obtain Ti/Sn-containing nanoparticles. After mixing the nanoparticle powder obtained with liquid phase PMMA monomer, and the mixture is polymerized to yield a PMMA-ceramic composite.

FIG. 9 illustrates an SEM (scanning electron micrograph) image of the some nanoparticles obtained, according to one embodiment. The left image shows microstructure of the nanoparticles; the bright part indicates the SnO₂-rich phase, and the dark part indicates the TiO₂-rich phase. The right image shows Ti/Sn-containing spherical nanoparticles.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An optical article comprising:
a light-transmissive substrate; and
Ti/Sn-containing nanoparticles,
wherein:
the nanoparticles comprise one or more Ti-rich phases and one or more Sn-rich phases, and
the phases being arranged in the form of a layered-structure, a network-structure of each other interconnected phases and/or an isolated-structure.

2. The optical article of claim 1, wherein the layered-structure is a lamellar structure.

3. The optical article of claim 1, wherein the layered-structure is a core-shell structure.

4. The optical article of claim 1, wherein the Ti/Sn-containing nanoparticles comprise one or more compounds of formula (Tiₓ,Sn_{y})O₂;
wherein x is greater than 0.5 and y is less than 0.5 in the Ti-rich phase; and x is less than 0.5 and y is greater than 0.5 in the Sn-rich phase.

5. The optical article of claim 4, wherein:
0.5<x<0.9, 0.1<y<0.5, and x+y=1 in the Ti-rich phase; and
0.1<x<0.5, 0.5<y<0.9, and x+y=1 in the Sn-rich phase.

6. The optical article of claim 1, wherein the Ti-rich phases, the Sn-rich phases, or both the Ti- and Sn-rich phases of the nanoparticles are rutile-type.

7. The optical article of claim 1, wherein the size of the nanoparticles is 200 nm or less.

8. The optical article of claim 1, wherein a distance between Ti-rich phases, or between Sn-rich phases is 100 nm or less.

9. The optical article of claim 1, wherein the nanoparticles are dispersed within the substrate.

10. The optical article of claim 9, wherein the content of nanoparticles in the substrate is from about 0.005 wt % to 0.5 wt % based on the total weight of the substrate.

11. The optical article of claim 1, wherein the nanoparticles are coated onto a surface of the substrate.

12. The optical article of claim 1 further comprising a film comprising nanoparticles dispersed therein is coated onto a surface of the substrate.

13. The optical article of claim 1, wherein a refractive index of the optical article is increased as compared to an optical article without the nanoparticles.

14. The optical article of claim 1, wherein a refractive index of the optical article is at least about 1.5.

15. The optical article of claim 1, wherein a refractive index of the optical article is less than about 2.7.

16. The optical article of claim 1, wherein the light-transmissive substrate comprises a polystyrene resin, a polycarbonate resin, a polymethyl methacrylate resin, a polydiethylene glycol bis (allyl carbonate) resin, a vinyl ester resin, a vinyl ether resin, a halogen-containing resin, an olefinic resin, a polyester resin, a polyamide-series resin, a thermoplastic polyurethane resin, a polysulfone resin, a polyphenylene ether resin, a cellulose derivative, a silicone resin, co-polymers thereof, or a mixture of any two or more thereof.

17. A device comprising the optical article of claim 1, wherein the device is an optical lens, a reflector, or a prism.

18. A method for preparing an optical article comprising:
providing Ti/Sn-containing nanoparticles, wherein:
the nanoparticles comprise one or more Ti-rich phases and one or more Sn-rich phases; and
the phases are arranged in the form of a layered-structure, a network-structure of each other interconnected phases and/or an isolated-structure;
mixing a curable light-transmissive liquid resin with the nanoparticles; and
curing the liquid resin to form the optical article.

19. The method of claim 18, wherein the providing Ti/Sn-containing nanoparticles comprises inducing spinodal decomposition by heating a Ti/Sn-containing solid solution of nanoparticles to separate the solid solution into one or more Ti-rich phases and one or more Sn-rich phases.

20. The method of claim 19, wherein the heating is carried out at a temperature of from about 700° C. to 1400° C.

21. The method of claim 18, wherein the layered-structure is a lamellar structure.

22. The method of claim 18, wherein the nanoparticles have a core-shell structure.

23. The method of claim 18, wherein the Ti/Sn-containing nanoparticles comprise one or more compounds of formula (Tiₓ,Sn_{y})O₂,
wherein:
x is greater than 0.5 and y is less than 0.5 in the Ti-rich phase; and
x is less than 0.5 and y is greater than 0.5 in the Sn-rich phase.

24. The method of claim 18, wherein the Ti-rich phases, the Sn-rich phases, or both the Ti- and Sn-rich phases of the nanoparticles are rutile-type.

25. The method of claim 18, wherein the size of the nanoparticles is 200 nm or less.

26. The method of claim 18, wherein a distance between the phases consisting of identical component is 100 nm or less.

27. The method of claim 18, wherein the nanoparticles are dispersed in the curable light-transmissive liquid resin.

28. The method of claim 18, wherein the content of nanoparticles in the curable composition is from about 0.005 wt % to 0.5 wt % based on the total amount of the liquid resin.

29. The method of claim 18, wherein the refractive index of the optical article is at least about 1.5.

30. The method of claim 18, wherein the light-transmissive liquid resin comprises a polystyrene resin, a polycarbonate resin, a polymethyl methacrylate resin, a polydiethylene glycol bis (allyl carbonate) resin, a vinyl ester resin, a vinyl ether resin, a halogen-containing resin, an olefinic resin, a polyester resin, a polyamide-series resin, a thermoplastic polyurethane resin, a polysulfone resin, a polyphenylene ether resin, a cellulose derivative, a silicone resin, co-polymers thereof, or a mixture of any two or more thereof.

31. A method for preparing an optical article comprising:
providing Ti/Sn-containing nanoparticles, wherein the nanoparticles comprise one or more Ti-rich phases and one or more Sn-rich phases, wherein the phases are arranged in the form of a layered-structure, a network-structure of each other interconnected phases and/or an isolated-structure; and
coating the nanoparticles onto a surface of a light-transmissive substrate to form an optical article.

32. A method for preparing an optical article comprising:
providing Ti/Sn-containing nanoparticles, wherein the nanoparticles comprise one or more Ti-rich phases and one or more Sn-rich phases, and the phases are arranged in the form of a layered-structure, a network-structure of each other interconnected phases and/or an isolated-structure;
mixing a curable light-transmissive liquid resin with the nanoparticles to form a composition;
coating the composition onto a surface of a light-transmissive substrate; and
curing the curable light-transmissive liquid resin form a film on the substrate.
